(19) United States
(12) Patent Application Publication
(10) Pub. No.: US 2023/0052555 A1
(43) Pub. Date: Feb. 16, 2023

(54) DEVICES AND METHODS FOR ASYNCHRONOUS AND SYNCRHONOUS WIRELESS COMMUNICATIONS UTILIZING A SINGLE RADIO

(71) Applicant: Texas Instruments Incorporated, Dallas, TX (US)

(72) Inventor: Seth Rickard, Dallas, TX (US)

(21) Appl. No.: 17/818,940

(22) Filed: Aug. 10, 2022

Related U.S. Application Data
(60) Provisional application No. 63/231,381, filed on Aug. 10, 2021.

(51) Int. Cl. H04W 76/15; H04L 5/00

(52) U.S. Cl. CPC H04W 76/15; H04L 5/003

(57) ABSTRACT

Devices and methods to provide simultaneous asynchronous and synchronous wireless communications, wherein communications with at least one wireless device are established using an asynchronous operation mode utilizing a first frequency band of a single radio device; and, the asynchronous operation mode is interrupted at periodic intervals to establish a synchronous operation mode utilizing a second frequency band of the single radio device, wherein the synchronous operation mode comprises: during a first of the periodic intervals, advertising at least a first of a plurality of available communication slots and listening for a slot petition from at least one end device; and, if a petition is received from at least one end device, assigning one of the plurality of available communication slots to each end device from which a petition was received, wherein each slot utilizes Coordinated Sampled Listening for both uplink and downlink communications with an assigned end device.

### RELATED APPLICATION

This application claims the benefit of U.S. Provisional Patent Application No. 63/231,381, filed Aug. 10, 2021, the disclosure of which is incorporated herein by reference.

### TECHNICAL FIELD

This disclosure is directed, in general, to wireless communications and, more specifically, to devices and methods for operation of asynchronous and synchronous communications over first and second radio frequency (RF) bands utilizing a single radio.

### BACKGROUND

IEEE 802.15.4 is a technical standard which defines the operation of a law-rate wireless personal area network (LR-WPAN). It is the basis, for example, of the Zigbee, Thread, and Wi-SUN specifications, each of which further extends the standard by developing the upper layers which are not defined in IEEE 802.15.4. Operation of a single network across two radio frequency (RF) bands with a single radio is not currently possible with most IEEE 802.15.4 implementations. Many deployments of IEEE 802.15.4 based technologies use an asynchronous non-beacon mode of personal area network (PAN) operation in the global 2.4 GHz industrial, scientific and medical (ISM) band. Zigbee and Thread are examples of popular mesh networking technologies based on this mode of operation.

It is desired to operate in the sub-1 GHZ RF spectrum (i.e., a radio frequency lower than 1 GHz) as well as the widely-utilized 2.4 GHz deployments; doing so can enable longer links within the network, more robust links through mediums like concrete, and will avoid the congested 2.4 GHz band. One challenge presented by sub-1 GHZ operation, however, is the onus of duty cycling mandated by certain regions' RF regulatory bodies. It is also desired to maintain existing operation within the 2.4 GHz RF spectrum; doing so will maintain global ISM operation mode and leverage the ubiquity of 2.4 GHz solutions. Operating as an IEEE 802.15.4 PAN coordinator in both bands, however, either requires two radios per device or time sharing between the RF spectrums. This will either result in a higher bill of material (BoM) cost for products or a reduced quality of service (QoS) as the PAN coordinator.

Accordingly, what is needed in the art are devices and methods that enable systems, such as a router, to operate in both 2.4 GHz and sub-1 GHZ RF bands with one radio. Preferably, the solution should preserve legacy operation in 2.4 GHz and should also limit the QoS degradation from operating in sub-1 GHZ as the 2.4 GHz PAN coordinator.

### SUMMARY

To address deficiencies of the prior art, disclosed is a router, and method for use in a router, to provide asynchronous and synchronous wireless communications utilizing a single radio. Communications with at least one wireless device are established using an asynchronous operation mode utilizing a first frequency band of a single radio device; the asynchronous operation mode is interrupted at periodic intervals to establish a synchronous operation mode utilizing a second frequency band of the single radio device. The synchronous operation mode comprises: during a first of the periodic intervals, advertising at least a first of a plurality of available communication slots and listening for a slot petition from at least one end device; and, if a petition is received from at least one end device, assigning one of the plurality of available communication slots to each end device from which a petition was received, wherein each slot utilizes Coordinated Sampled Listening for both uplink and downlink communications with an assigned end device. In an example, in subsequent occurrences of the periodic intervals, it is determined whether a link is established with an end device via one or more of the plurality of communication slots; if a link has not been established with an end device assigned to a slot, a process to establish a link with the end device is continued; otherwise, if a link has been established with an end device, uplink or downlink data is exchanged with an end device during its assigned communication slot. The router returns to the asynchronous operation mode at the termination of each periodic interval.

In an example, the first frequency band of operation is 2.4 GHz for the asynchronous mode of operation; in a related example, the second frequency band of operation can be sub-1 GHz for the synchronous mode of operation.

In certain examples, the number of the plurality of slots is a function of the number of end devices to be simultaneously supported. The duration of the plurality of communication slots of the synchronous operation mode can be a function of a predefined quality of service for the asynchronous operation mode. In a related example, the duration of all of the plurality of communication slots of the synchronous operation mode in a predefined period does not exceed 1% of the period. The plurality of communication slots can be spread across a plurality of channels within the second frequency band of operation.

The foregoing has outlined, rather broadly, the general features of the disclosed examples so that those skilled in the art may better understand the detailed description of the examples that follows. Those skilled in the art should appreciate that they can readily use the disclosed conception and example as a basis for designing or modifying other structures and methods for carrying out the same purposes of the present disclosure. Those skilled in the art should also realize that such equivalent constructions do not depart from the spirit and scope of the disclosure in its broadest form.

### BRIEF DESCRIPTION OF THE DRAWINGS

For a more complete understanding of the disclosure, reference is made to the following detailed description taken in conjunction with the accompanying drawings, in which:

FIG. 1 illustrates router communication modes for certain prior art 2.4 GHz end devices and a novel communication mode for CSL devices utilizing synchronous sub-1 GHZ communications for both uplinks and downlinks;

FIG. 2 illustrates the basic methodology for implementing router communications for CSL devices utilizing synchronous sub-1 GHZ communications for both uplinks and downlinks; and,

FIG. 3 illustrates a flowchart of how to use a synchronous slot for the basic methodology illustrated in FIG. 2.

### DETAILED DESCRIPTION

In order to provide systems, such as a router, that operate in both 2.4 GHz and sub-1 GHZ RF bands with one radio, the following solution proposes to implement sub-1 GHZ operation with a synchronous mode, while 2.4 GHz operation is implemented using a conventional asynchronous mode of operation. The 2.4 GHz asynchronous mode of operation will see minimal impact to QoS; any degradation in QoS will be limited to only what is necessary to support end devices within the sub-1 GHZ network. This is because the RX-on-idle requirement of a PAN coordinator will not be required in a synchronous network; which, as those skilled in the art understand, means that the synchronous communication channel does not require idle reception for communication in either direction. Any loss in QoS will simply appear to 2.4 GHz devices connected to the PAN coordinator as hidden node interference.

The proposed mechanism for synchronous communication in sub-1 GHZ is Coordinated Sampled Listening (CSL); see IEEE Standard 802.15.4-2020, section 6.12.2, et seq., incorporated herein by reference. This mode of operation is a standardized way for synchronized devices to send and receive without the need for the PAN coordinator to provide RX-on-idle functionality. Synchronous CSL has been defined as a mode of operation for synchronized sleepy end devices (SSED) within the Thread 1.2.0 Specification (June 2019), incorporated herein by reference; that functionality will be extended to enable multi-channel operation in order to work around mandated duty-cycle requirements of certain regulatory bodies.

Synchronized CSL as defined in Thread 1.2.0 assumes synchronization and attaching to a network is done outside of the CSL framework. Operation on advertisement channels within sub-1 GHZ will be implemented to enable CSL only operation. This mode of operation can allow devices to discover a Thread network, petition the network, join the network, and attach as end devices to the network. Through the extension of Thread 1.2.0 CSL and implementation of advertisement channels within sub-1 GHZ, it will thus be possible to operate a synchronous IEEE 802.15.4 network in parallel with a 2.4 GHz asynchronous IEEE 802.15.4 network, in contrast to conventional networking solutions that do not simultaneously operate within 2.4 GHz and sub-1 GHZ RF bands.

Frequency hopping schemes for sub-1 GHZ networks either use a proprietary hopping and synchronization method or use time slotted (or synchronized) channel hopping (TSCH). Existing protocols, however, do not primarily use CSL for communication. Existing protocols also do not use an advertisement scheme based on CSL for sub-1 GHZ communications. The solution disclosed herein offers a unified network in two RF domains while only requiring a single radio for operation. According to the principles of the proposed solution, the creation of a mode for IEEE 802.15.4 devices operates with only CSL to allow IEEE 802.15.4 PAN coordinators to maintain end devices in other RF spectrum (e.g., sub-1 GHZ) with different characteristics to the traditional 2.4 GHz operation, while maintaining conventional asynchronous 2.4 GHz operation. The solution also enables compliance with mandated duty cycle requirements from RF regulatory bodies without the necessity of complex frequency hopping mechanisms.

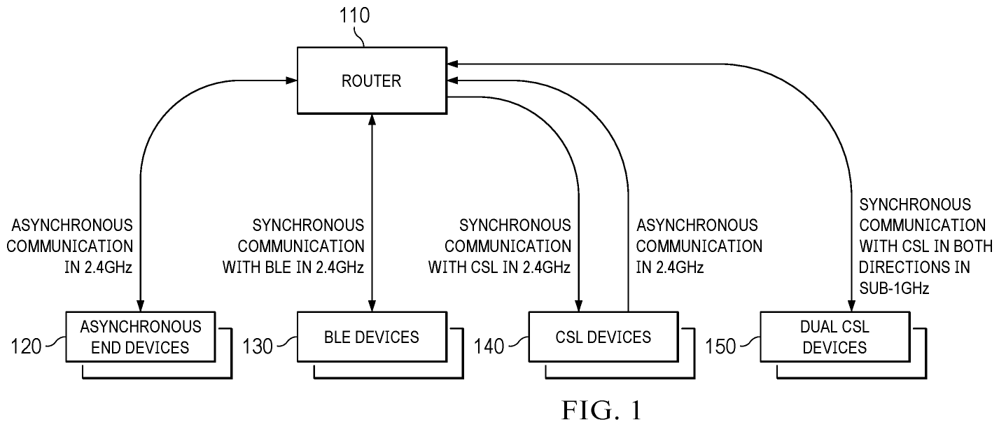

Referring first to FIG. 1, illustrated is router communication modes for certain prior art 2.4 GHz end devices and a novel communication mode for CSL devices utilizing synchronous sub-1 GHZ communications for both uplinks and downlinks. As known in the art, a router 110 can communicate with various types of end devices in accordance with standard protocols, including conventional asynchronous end devices 120, Bluetooth® Low Energy (BLE) devices 130, and CSL devices 140. Conventional asynchronous end devices 120 utilize asynchronous communications in the 2.4 GHz band; BLE devices 130 utilize synchronous communications according to the BLE standard, also in the 2.4 GHz band; CSL devices 140, according to the 802.15.4 standard, utilize synchronous communications with CSL in the downlink, but asynchronous communications for uplinks, both of which are in the 2.4 GHz band. According to the principles disclosed herein, router 110 can also communicate with “dual” CSL devices 150, utilizing synchronous communications with CSL for both uplinks and downlinks, but using a sub-1 GHZ band.

CSL is used by the Thread 1.2.0 Specification for Synchronized Sleepy End Devices (SSED). After the normal attachment process, a CSL device 140 can configure CSL operation if a version 1.2 router is available. Such devices will synchronize TX/RX windows so the end device can receive notifications from the router 110 by only opening its receiver; the uplink, however, is still asynchronous between CSL devices 140 and the router 110. According to the principles disclosed herein, the addition of synchronous CSL communication on the uplink allows the “dual” end devices 150 to operate without legacy (i.e., 2.4 G Hz) network operation; this allows the link over sub-1 GHZ to be longer or to operate in hostile environments without the need for the router 110 to be always receiving in the channel.

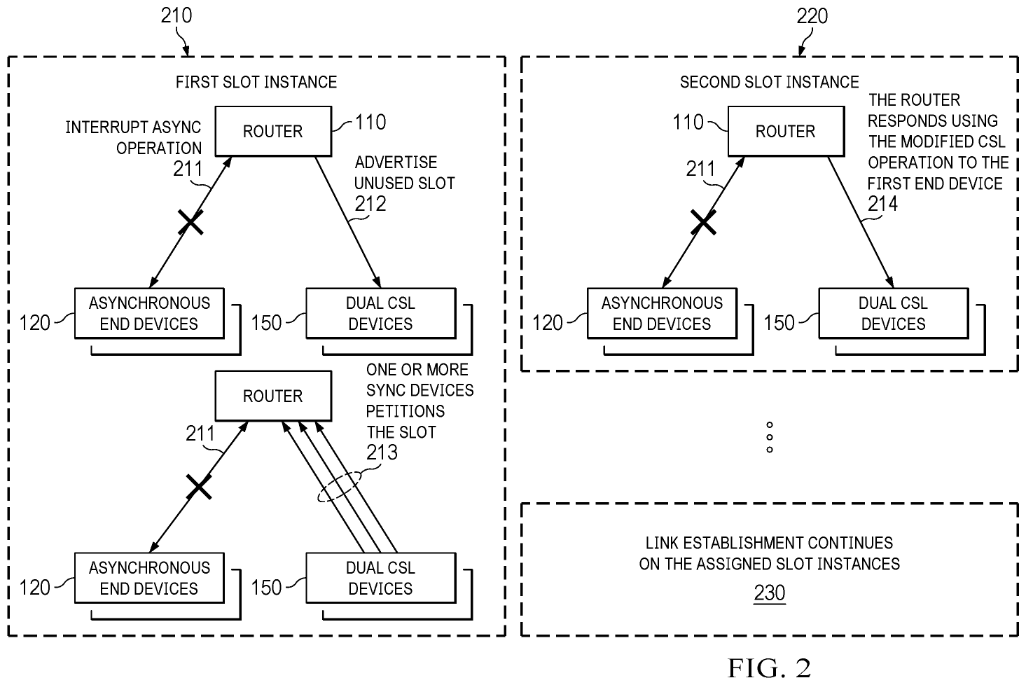

Turning now to FIG. 2, illustrated is the basic methodology for implementing router communications for CSL devices utilizing synchronous sub-1 GHZ communications for both uplinks and downlinks. During a first slot instance 210, the router 110 interrupts any established asynchronous operations with at least one asynchronous end device 120; the asynchronous communications mode utilizes a first frequency band (e.g., 2.4 GHz) of the router radio. The router 110 then, during the interruption of the asynchronous communication mode, advertises at least one of a plurality of available communication slots 212 utilizing a second frequency band (e.g., sub-1 GHZ) of the router radio. In response to the advertisement, one or more CSL devices 150 having the capability to utilize CSL for both uplink and downlink can broadcast a petition 213 to be assigned the available communication slot; the router 110, in response to a received petition from at least one dual CSL end device 150, assigns one of the plurality of available communication slots to each dual CSL end device 150 from which a petition was received, wherein each slot will utilize CSL for both uplink and downlink communications with an assigned end device. An advertised slot will be taken by the first device to respond; other responding devices will wait for another advertisement period to be assigned a slot. In subsequent occurrences of the periodic intervals during which the asynchronous operation mode is interrupted by router 110 (e.g., second slot instance 220), it is determined whether a link is established with an end device via one or more of the plurality of communication slots; if so, the router utilizes the “modified” synchronous CSL mode to communicate with any attached dual CSL end devices 150 for both uplinks and downlinks. If additional dual DSL end devices 150 are assigned communication slots, then link establishment and/or communications with such devices is performed during subsequent occurrences of the assigned communication slots 230.

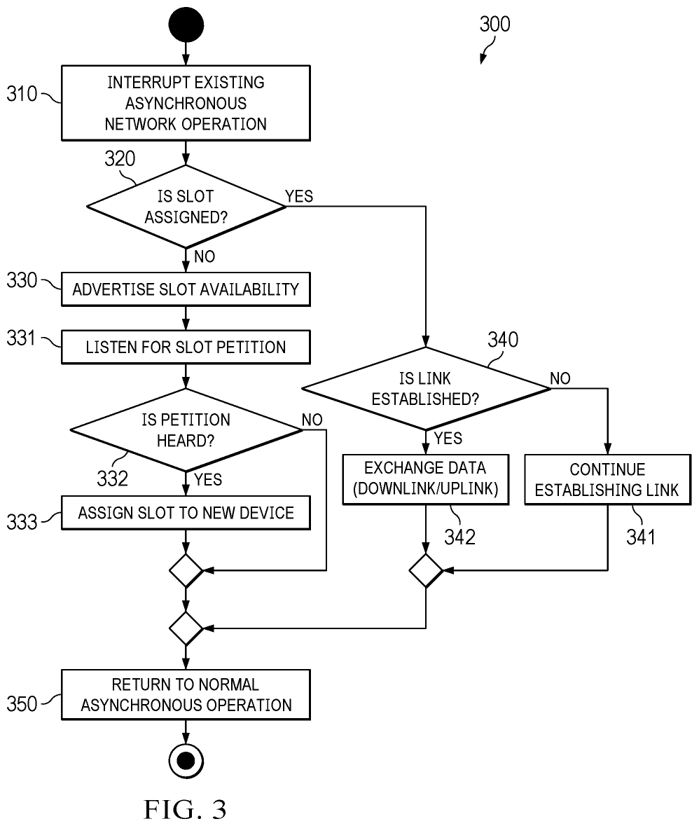

Turning now to FIG. 3, with continuing reference to FIG. 1, illustrated is a flowchart 300 of how to use a synchronous slot for the basic methodology illustrated in FIG. 2. In a first step 310, any existing asynchronous operations utilizing a first frequency band of router 110 are interrupted; e.g., any communications with asynchronous end devices 120 or asynchronous uplink communications with CSL devices 140. The asynchronous mode is interrupted at periodic intervals to service synchronous mode devices utilizing a second frequency band of the radio of router 110.

Next, in a step 320, it is determined whether a synchronous mode communication slot, utilizing the second frequency band, is assigned to any end devices, such as dual CSL devices 150. If not, in a step 330, router 110 advertises at least a first of a plurality of available communication slots; the router then, in a step 331, listens for any petitions from an end device to be assigned the slot. In a step 332, if no petition is received within a predefined interval, the router 110 returns to normal asynchronous operations (step 350). If, however, a petition is received by router 110, then an advertised slot is assigned to a device from which a petition was received (step 333); the router 110 then returns to normal asynchronous operations (step 350). If, in step 320, it is determined that a synchronous mode communication slot, utilizing the second frequency band, is assigned to an end device, such as dual CSL devices 150, then it is determined in step 340 whether a link has been established with such device(s); it not, then the process to establish such link(s) is continued in step 341. If such link(s) are established with one or more dual CSL devices 150, then data is exchanged with such device(s), on both the uplink and downlink, in step 342. Once the period of each assigned slot terminates, then the router 110 returns to normal asynchronous operations (step 350).

The number of slots, their period and channel may be assigned based on a number of factors. These include but are not limited to; the number of end devices that a product needs to support, regulatory compliance with local laws, and how much to impact the existing asynchronous network. More slots should be allocated if the end product needs to support more end device connections. To comply with the European Telecommunications Standards Institute (ETSI) regulations, the number and duration of slots must be less than 1% per 200 khz channel. To enable more connections on ETSI the number of channels used for slots can be increased. To comply with Federal Communications Commission (FCC) regulations, a slot may span across multiple channels per each occurrence of the slot. To limit the impact on the existing asynchronous network, it is recommended that the sum of all the slots in a given time period not exceed 1% of that time period.

The technical principles disclosed herein provide a foundation for designing devices and methods for simultaneous operation of asynchronous and synchronous communications over first and second radio frequency (RF) bands utilizing a single radio. The functionality disclosed herein can be implemented in various devices, such as routers, using conventional hardware, software or firmware, or a combination thereof. The examples presented herein illustrate the application of the technical principles and are not intended to be exhaustive or to be limited to the specifically disclosed network devices or methods of operation; it is only intended that the scope of the technical principles be defined by the claims appended hereto, and their equivalents.

We claim:

1. A method in a router having a single radio device to provide asynchronous and synchronous wireless communications, said method comprising the steps of:
establishing communications with at least one wireless device using an asynchronous operation mode utilizing a first frequency band of operation of said single radio device; and,
interrupting said asynchronous operation mode at periodic intervals to establish a synchronous operation mode utilizing a second frequency band of operation of said single radio device, wherein said synchronous operation mode comprises:
during a first of said periodic intervals, advertising at least a first of a plurality of available communication slots and listening for a slot petition from at least one end device; and,
in response to receiving a petition from at least one end device, assigning one of said plurality of available communication slots to each end device from which a petition was received, wherein each slot utilizes Coordinated Sampled Listening for both uplink and downlink communications with an assigned end device.

2. The method recited in claim 1, further comprising in subsequent occurrences of said periodic intervals, the steps of:
determining whether a link is established with an end device via one or more of said plurality of communication slots;
in response to not establishing a link with an end device assigned to a slot, establish a link with said end device; and,
in response to establishing a link with an end device, exchanging uplink or downlink data with said end device during its assigned communication slot.

3. The method recited in claim 1, wherein said router returns to said asynchronous operation mode at a termination of each periodic interval.

4. The method recited in claim 1, wherein said first frequency band of operation is 2.4 GHz.

5. The method recited in claim 1, wherein said second frequency band of operation is sub-1 GHz.

6. The method recited in claim 1, wherein a number of said plurality of slots is a function of a number of end devices to be supported.

7. The method recited in claim 1, wherein a duration of said plurality of communication slots of said synchronous operation mode is a function of a predefined quality of service for said asynchronous operation mode.

8. The method recited in claim 7, wherein the duration of all of said plurality of communication slots of said synchronous operation mode in a predefined period does not exceed 1% of said period.

9. The method recited in claim 1, wherein said plurality of communication slots are spread across a plurality of channels within said second frequency band of operation.

10. A router having a single radio device to provide asynchronous and synchronous wireless communications, said router comprising:
means for establishing communications with at least one wireless device using an asynchronous operation mode utilizing a first frequency band of operation of said single radio device; and,
means for interrupting said asynchronous operation mode at periodic intervals to establish a synchronous operation mode utilizing a second frequency band of operation of said single radio device, wherein said synchronous operation mode comprises:
during a first of said periodic intervals, advertising at least a first of a plurality of available communication slots and listening for a slot petition from at least one end device; and,
in response to receiving a petition from at least one end device, assigning one of said plurality of available communication slots to each end device from which a petition was received, wherein each slot utilizes Coordinated Sampled Listening for both uplink and downlink communications with an assigned end device.

11. The router recited in claim 10, further comprising:
means for determining, in subsequent occurrences of said periodic intervals, whether a link is established with an end device via one or more of said plurality of communication slots;
means for, in response to not establishing a link with an end device assigned to a slot, establishing a link with said end device; and,
means for, in response to establishing a link with an end device, exchanging uplink or downlink data with said end device during its assigned communication slot.

12. The router recited in claim 10, wherein said router returns to said asynchronous operation mode at a termination of each periodic interval.

13. The router recited in claim 10, wherein said first frequency band of operation is 2.4 GHz.

14. The router recited in claim 10, wherein said second frequency band of operation is sub-1 GHz.

15. The router recited in claim 10, wherein a number of said plurality of slots is a function of a number of end devices to be supported.

16. The router recited in claim 10, wherein a duration of said plurality of communication slots of said synchronous operation mode is a function of a predefined quality of service for said asynchronous operation mode.

17. The router recited in claim 16, wherein the duration of all of said plurality of communication slots of said synchronous operation mode in a predefined period does not exceed 1% of said period.

18. The router recited in claim 10, wherein said plurality of communication slots are spread across a plurality of channels within said second frequency band of operation.
